(19) United States
(12) Patent Application Publication
(10) Pub. No.: US 2009/0198861 A1
(43) Pub. Date: Aug. 6, 2009

(54) Device With A USB Interface Which Can Be Used As A Time-Sharing Standard I/O Interface And A Method Thereof

(75) Inventors: Zhou LU, Beijing (CN); Huazhang YU, Beijing (CN)

Correspondence Address: HARNESS, DICKEY & PIERCE, P.L.C., P.O. BOX 828, BLOOMFIELD HILLS, MI, 48303, US

(73) Assignee: Feitian Technologies Co., Ltd., Beijing (CN)

(21) Appl. No.: 12/349,589

(22) Filed: Jan. 7, 2009

(30) Foreign Application Priority Data
Feb. 5, 2008 (CN) 200810057715.5

(51) Int. Cl. G06F 13/36

(52) U.S. Cl. 710/315

(57) ABSTRACT

The invention provides a device with a USB interface which can be used as a time-sharing standard I/O interface. The device includes a USB interface module, a status detecting module, a power extracting module and a switch module. The power extracting module is connected to the USB interface module, the switch module is connected to the USB interface module, and the status detecting module is connected to the switch module and the USB interface module. With an interface used in a time-sharing way according to the invention, the device can transfer data according to the USB protocol or standard I/O interface protocol depending on the tool used. When the data needs to be transferred according to the I/O interface protocol, there is no need to open the casing of the USB device and it is more convenient to use because the I/O interface protocol can be defined by the user.

### CROSS REFERENCE TO RELATED APPLICATION

This application claims a priority to Chinese application No. 200810057715.5 submitted to the State Intellectual Property Office on Feb. 5, 2008 and entitled “A DEVICE WITH A USB INTERFACE WHICH CAN BE USED AS A TIME-SHARING STANDARD I/O INTERFACE AND A METHOD THEREOF”, the content of which is incorporated herein by reference in its entirety.

### FIELD OF THE INVENTION

The present invention relates to the field of information security, and in particular to a device with a USB interface which can be used as a time-sharing standard I/O interface and a method thereof.

### BACKGROUND OF THE INVENTION

The Universal Serial Bus (USB) protocol permits a peripheral device to be connected to or disconnected from a computer which is working with another connected peripheral device, which is the function of plug and play. Meanwhile, the using of USB decreases the quantity of the I/O interfaces on a Personal Computer (PC) and replaces them by one serial channel, which facilitates the connection between the PC and a peripheral device.

A USB interface transfers the signal and power via a quad cable which comprises four signal lines: D+, D−, GNG and Vbus. D+ and D− are a pair of differential mode signal lines, while Vbus (high level) and GND (ground) provide the power for some devices including USB hub. And USB provides two kinds of data transfer rate: one is 12 Mbps, i.e. full speed mode, and the other is 1.5 Mbps, i.e. slow speed mode. Both of the modes can be used in a USB system. Mainly the application of slow speed mode is for decreasing the cost of device with low configuration such as a mouse, a keyboard, etc.

In the prior art, communication only based on USB protocol is not enough for some USB devices. For example, the casing of the USB device need to be opened when the USB device is updated or extracts data via the standard I/O interface protocol, which is inconvenient.

### SUMMARY OF THE INVENTION

To eliminate the limitation that the data can not be transferred via a standard I/O interface without opening the casing of the USB device as an enclosed device. The invention presents a device with a USB interface which can be used as a time-sharing standard I/O interface and a method thereof. On the basis of the USB protocol communication, a way of standard I/O interface protocol data communication is added for the USB device.

A device with a USB interface which can be used as a time-sharing standard I/O interface, comprises a USB interface module, a status detecting module, a power extracting module and a switch module, the power extracting module is connected to the USB interface module, the switch module is connected to the USB interface module, the status detecting module is connected to the switch module and the USB interface module respectively, wherein

the status detecting module is adapted to detect voltages on USB interface signal lines to determine whether the signal voltage sequence on the USB interface signal lines is a USB protocol sequence;

the power extracting module is adapted to convert the voltages of input signals in any sequence to voltages in the USB protocol sequence; and

the switch module is adapted to switch a D+ signal line and/or a D− signal line arranged in the USB protocol sequence to an I/O interface, via which the device can exchange data, if the status detecting module determines that the signal voltage sequence accords with the USB protocol; otherwise, the device can exchange data with an upstream interface via D+ and D− interfaces on the basis of the USB protocol.

The switch module is a switch chip, a controllable switch or a relay.

The switch chip is a CD4052 chip.

The status detecting module is a status detecting circuit.

The power extracting module is a silicon stack diode power converting circuit, a relay power converting circuit or a controllable switch power converting circuit.

The relay power converting circuit comprises two relays which are reverse-connected with each other, each relay has two contacts which form two series loops which are reverse-connected, a power output interface is connected between the two contacts of the series loops.

The silicon stack diode power converting circuit comprises four bridge-connected diodes, and among the four output points, two output points each connecting a positive terminal of a diode and a negative terminal of another diode are connected to the USB interface module.

A method for a USB interface which can be used as a time-sharing standard I/O interface includes the following steps:

connecting the device to an upstream interface; and

extracting power and detecting status for the upstream interface by the device, so that when the detected sequence of voltages on signal lines accords with the USB protocol, data can be exchanged according to the USB protocol by the device; otherwise, switching the D+ signal line and D− signal line to a standard I/O interface via which data can be exchanged.

The upstream interface is an upstream interface with which data is exchanged via a USB interface or an I/O interface.

The voltage status on signal lines of the upstream interface with which data is exchanged via the I/O interface is arranged in any sequence.

The step of extracting power for the upstream interface by the device includes: adjusting the sequence of voltages on Vbus and Gnd signal lines to accord with the USB protocol to provide a normal voltage to the device.

The step of exchanging data by the device according to the USB protocol includes: when the sequence of the voltages on the signal lines is normal, connecting the D+ and D− signal lines to D+ and D− interfaces after passing through a switch, and exchanging data with the upstream interface according to the USB protocol.

As described above, in the prior art, where the USB device only accords with the USB protocol, there is a limitation in the data exchange of the USB device with other devices, and also it is inconvenient for the USB device to update the firmware when the USB device can not use the USB protocol for update. Therefore, with the USB interface used in a time-sharing way, the device can transfer data with the USB protocol or standard I/O interface protocol depending on the tool used. When the data needs to be transferred with the standard I/O interface protocol, there is no need to open the casing of the USB device for data exchange. In addition, the USB protocol is a predefined one, while the standard I/O interface protocol is defined by the user, which brings more convenience.

### BRIEF DESCRIPTION OF THE DRAWINGS

FIG. 1 shows a structural diagram of a device with a USB interface which can be used as a time-sharing standard I/O interface.

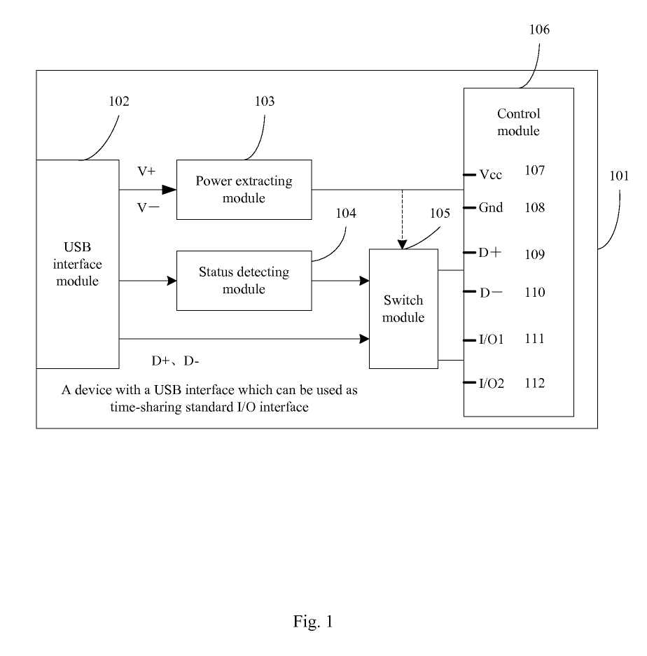

FIG. 2 shows a circuit diagram of a device with a USB interface which can be used as a time-sharing standard I/O interface.

FIG. 3 shows a circuit diagram of a device with a USB interface which can be used as a time-sharing standard I/O interface.

FIG. 4 shows a circuit diagram of a device with a USB interface which can be used as a time-sharing standard I/O interface.

FIG. 5 shows a circuit diagram of a device with a USB interface which can be used as time-sharing standard I/O interface.

FIG. 6 shows a flowchart of a method for a device with a USB interface which can be used as a time-sharing standard I/O interface.

### DETAILED DESCRIPTION OF THE PREFERRED EMBODIMENTS

The present invention is further described below with reference to the embodiments and the drawings, which is not to limit the present invention.

In order to eliminate inconvenience and limitation that a USB device as an enclosed device can not exchange data via the standard I/O interface without opening the casing, a way of data exchange according to the standard I/O interface protocol is added on the basis of the USB protocol.

### Embodiment 1

A device 101 with a USB interface which can be used as a time-sharing standard I/O interface comprises:

a status detecting module 104 adapted to detect the voltages of the USB interface signal lines to determine whether the signal voltage sequence of the USB interface signal lines is a USB protocol sequence, when the device is connected to a host computer or a dedicated tool;

a power extracting module 103 adapted to convert the input signal voltages arranged in any sequence at the USB interface to the working voltage Vcc (107) and Gnd (108) arranged in the sequence of the USB protocol no matter the status of the Vbus and Gnd signal lines among the signal lines of the host computer or the dedicated tool is normal or not when the device is connected to the host computer or the specified tool;

a switch module 105 adapted to switch the D+ signal line (109) and/or the D− signal line (110) according to the USB protocol to an I/O interface 1 (111) and an I/O interface 2 (112), via which the device can exchange data with the dedicated toll, if the status detecting module determines that the signal voltage sequence accords with the USB protocol; otherwise, the device can exchange data with an upstream interface via D+ and D− interfaces on the basis of the USB protocol; and

a USB interface module 102 adapted for the device to perform data exchange through the USB protocol or I/O interface.

Preferably, the device 101 with a USB interface which can be used as a time-sharing standard I/O interface includes a control module 106 which connects to the power extracting module 103 and the switch module 105 respectively.

The host computer includes but not limit to a desktop computer, a laptop, a server, a dedicated computer, a card reader, a communication device, a hub, a PDA, etc.

The dedicated tool includes a production tool, a testing tool, a download tool and a data extracting device.

There is no need to open the casing when the USB device updates or downloads software with the dedicated tool, so the USB device can perform the data exchange directly with the dedicated tool via the I/O interface.

The status detecting module is connected to the switch module and USB interface module respectively. The power extracting module is connected to the USB interface module.

The power extracting module can be also connected to the switch module and supplies power for the switch module.

The switch module can be a switch chip, a control switch, a relay, a connector, etc.

The status detecting module can be an interface detecting circuit.

The power extracting module is a silicon stack diode power converting circuit, a relay power converting circuit or a controllable switch power converting circuit.

The relay power converting circuit comprises two relays which are reverse-connected with each other, each relay has two contacts which form two series loops which are reverse-connected, a power output interface is connected between the two contacts of the series loops.

The silicon stack diode power converting circuit comprises four bridge-connected diodes, and among the four output points, two output points each connecting a positive terminal of a diode and a negative terminal of another diode are connected to the USB interface module.

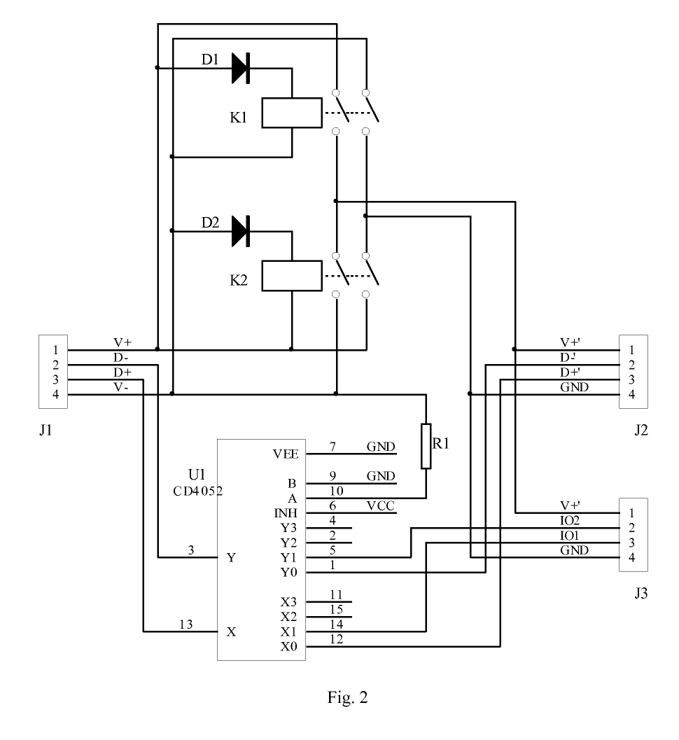

A circuit diagram according to an embodiment of the present invention is provided to give a detailed illustration for the device described above. Referring to FIG. 2, a dedicated tool or a host computer is connected to the device via J1 interface. The four signal lines of the J1 interface are Vbus signal line, D− signal line, D+ signal line and Gnd signal line. A power converting circuit comprising a D1 diode, D2 diode, K1 relay and K2 relay is adapted for supplying normal working voltage to the USB device no matter the power sequence in the connection lines is normal or reverse. Meanwhile, with the function of the status detecting, the R1 resistance is adapted for detecting the sequence of the Vbus signal line, D− signal line, D+ signal line and Gnd signal line of the dedicated device when the USB device connects to the dedicated tool or the host computer. If the sequence of the signal lines is normal, the D+ and D− signal lines are not switched after passing through the switch. And the four signal lines received by interface J2 are Vbus signal line, D− signal line, D+ signal line and Gnd signal line. So the data exchange with the host computer is performed according to the USB protocol. If the signal lines are not connected in a normal sequence, the switch that uses a chip CD4052 is adapted for switching the D+ and D− signal lines to the I/O interface 1 and I/O interface 2, and the four signal lines received by J3 are Vbus signal line, I/O interface 1, I/O interface 2 and GND signal line. So the data exchange is performed via the I/O interface with the dedicated tool by the device.

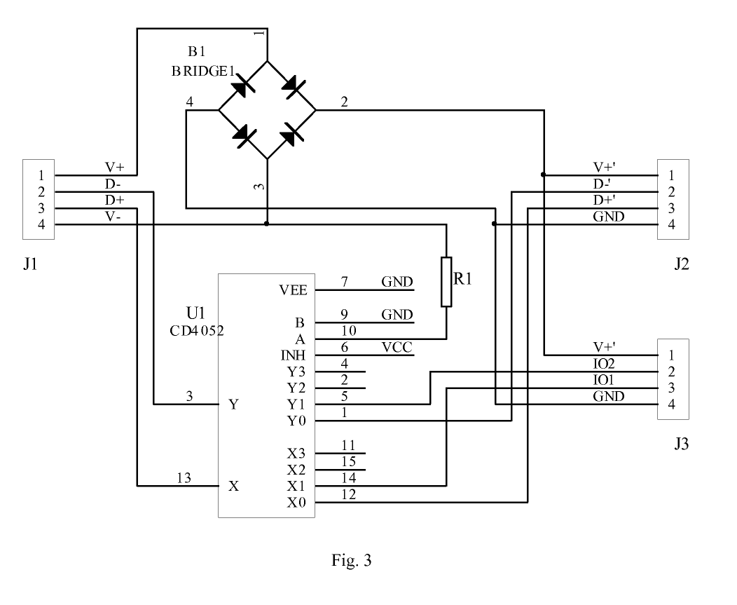

Several alternatives are possible to the embodiment. For example, referring to FIG. 3, a dedicated tool or a host computer is connected to the device via J1 interface. The four signal lines of the interface J1 are Vbus signal line, D− signal line, D+ signal line and Gnd signal line. The power converting circuit comprising a silicon stack diode is adapted to supply the normal working voltage to the USB device no matter the power sequence in the connection lines is normal or reverse. Meanwhile, with the function of the status detecting, the resistance R1 is adapted to detect the sequence of the Vbus signal line, D− signal line, D+ signal line and GDN signal line of the dedicated device when the USB device is connected to the dedicated tool or the host computer. If the sequence of the signal lines is normal, the D+ and D− signal lines are not switched after passing through the switch. And the four signal lines received by interface J2 are Vbus signal line, D− signal line, D+ signal line and GND signal line. So the data exchange with the host computer is performed according to the USB protocol. If the signal lines are not connected in a normal sequence, the switch that uses a chip CD4052 is adapted to switch the D+ and D− signal lines to the I/O interface 1 and I/O interface 2, and the four signal lines received by interface J3 are Vbus signal line, I/O interface 1, I/O interface 2 and GND signal line. So the data exchange is performed via the I/O interface with the dedicated tool by the device.

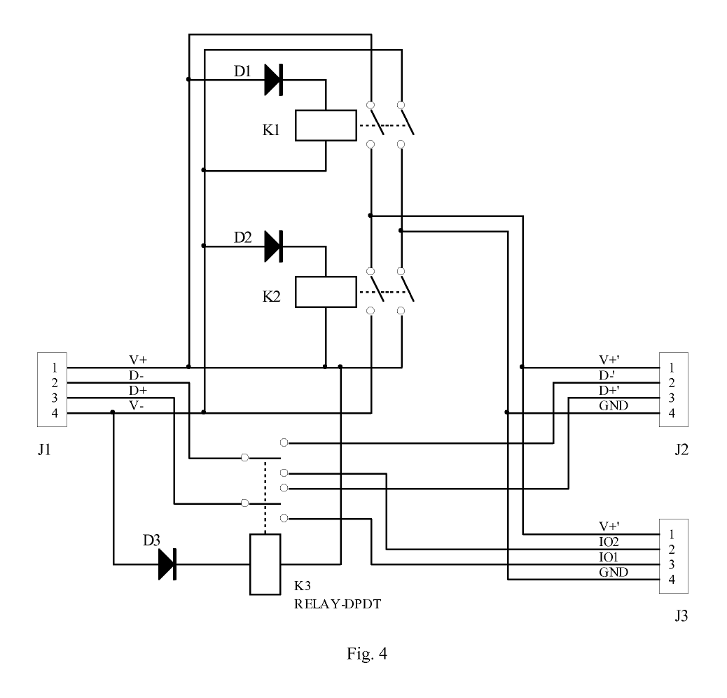

Referring to FIG. 4, a dedicated tool or a host computer is connected to the device via interface J1. The four signal lines of interface J1 are Vbus signal line, D− signal line, D+ signal line and GND signal line. The power converting circuit comprising diode D1, diode D2, relay K1 and relay K2 is adapted for supplying normal working voltage to the USB device no matter the power sequence in the connection lines is normal or reverse. Meanwhile, with the function of the status detecting and switching, relay K3 is connected to D+ and D− signal lines of J2 when Vbus signal line and GND signal line are connected in a normal sequence. And the four signal lines received by interface J2 are Vbus signal line, D− signal line, D+ signal line and GND signal line. So the data exchange with the host computer is performed according to the USB protocol. When the Vbus signal line and GND signal line are not connected in a normal sequence, relay K3 is connected to D+ and D− signal lines of J3. The four signal lines received by J3 are Vbus signal line, I/O interface 1, I/O interface 2 and GND signal line. So the data exchange is performed via the I/O interface with the dedicated tool by the device.

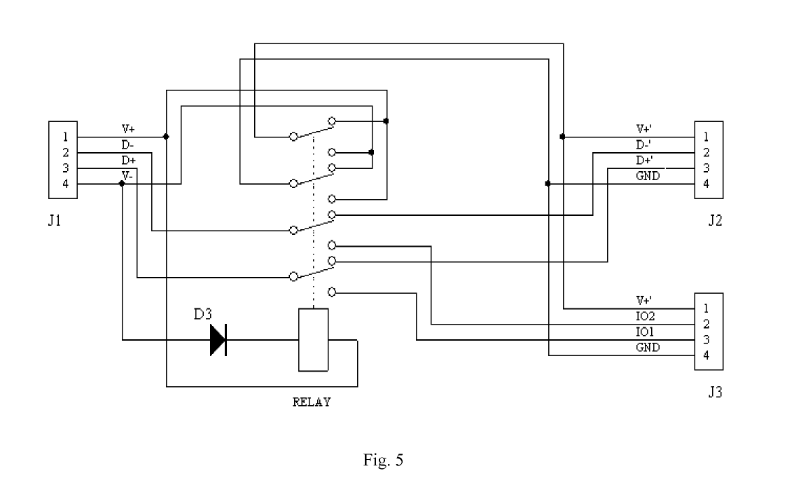

Referring to FIG. 5, a dedicated tool or a host computer is connected to the device via interface J1. The four signal lines of interface J1 are Vbus signal line, D− signal line, D+ signal line and GND signal line. The two switches in the upper part are adapted for supplying normal working voltage for the USB device no matter the power sequence in the connection lines is normal or reverse. The function of relay D3 is detecting the status. The two switches in the lower part are used for switching. When the Vbus signal line and GND signal line are connected in a normal sequence, D3 is connected to D+ and D− signals of interface J2. And the four signal lines received by interface J2 are Vbus signal line, D− signal line, D+ signal line and GND signal line. So the data exchange with the host computer is performed according to the USB protocol. When the Vbus signal line and GND signal line are not connected in a normal sequence, D3 is connected to D+ and D− signal lines of interface J3. The four signal lines received by J3 are Vbus signal line, I/O interface 1, I/O interface 2 and GND signal line. So the data exchange is performed via the I/O interface with the dedicated tool by the device.

### Embodiment 2

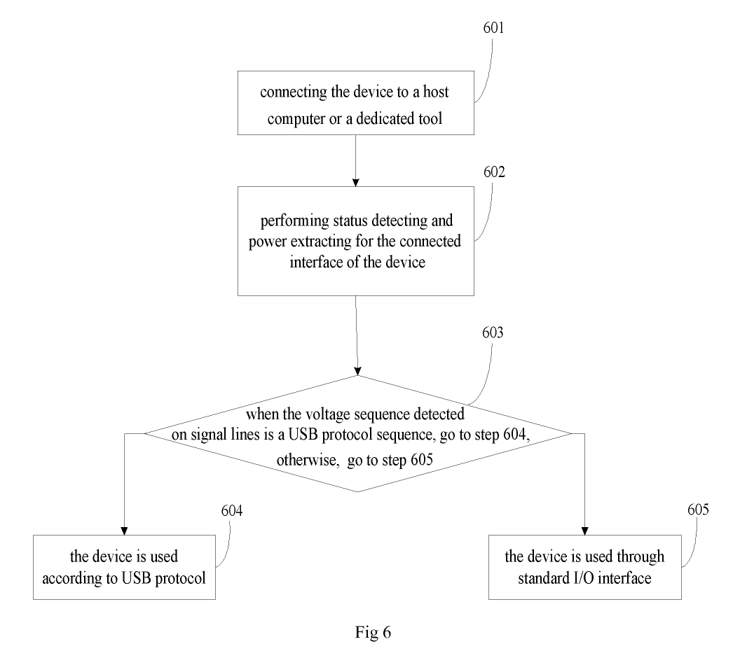

A method for a USB interface which can be used as a time-sharing standard I/O interface, referring to FIG. 6, comprises the following steps.

Step 601: the device is connected to a host computer or a dedicated tool.

The host computer includes but not limit to a desktop computer, a laptop, a server, a dedicated computer, a card reader, a communication device, a hub, a PDA, etc.

The dedicated tool includes a production tool, a testing tool, a download tool, a data extracting device, etc.

Step 602: status detection and power extraction are performed for the connected interface of the device.

The status detection includes detecting the voltages on the USB interface signal lines when the device is connected to the host computer or dedicated tool and determining whether the sequence of the voltages on the USB interface signal lines is a USB protocol sequence.

The power extraction includes converting the signal voltages inputted to the USB interface arranged in any sequence to the working voltage Vcc and Gnd arranged in the USB protocol sequence no matter the status of the Vbus signal line or Gnd signal line is normal or not when the device is plugged into the host computer or the dedicated tool.

Step 603: when the voltage sequence detected on the signal lines is a USB protocol sequence, go to step 604, otherwise, go to step 605.

Step 604: the device is used according to the USB protocol and the process ends.

Step 604 includes performing data exchange with the host computer via D+ and D− interfaces according to the USB protocol by the device when the voltage sequence detected on the signal lines is a USB protocol sequence.

Step 605: the device is used through a standard I/O interface.

When the voltage sequence detected on the signal lines is not the USB protocol sequence, D+ signal line and D− signal line arc switched to the I/O interface 1 and I/O interface 2 by a switch and thus connected to the CPU or an extended digital I/O interface for data exchange.

When the USB device updates and downloads software with the dedicated tool, the device performs the data exchange via an I/O interface directly with the dedicated tool without opening the casing.

The USB controller is a dedicated CPU, a dedicated part, etc.

The USB controller can be a built-in one in the CPU or an external one.

The data communication via the I/O interface includes updating, downloading, and testing software of the USB device and extracting data from the USB device.

The switch is a switch chip, a control switch, a relay, a contactor, etc.

The presently disclosed embodiments should be considered in all respects to be illustrative and not restrictive. The scope of the invention is indicated by the appended claims rather than the foregoing description, and all variations which come within the meaning and range of equivalents thereof are intended to be embraced therein.

What is claimed is:

1. A device with a USB interface which can be used as a time-sharing standard I/O interface, comprising a USB interface module, wherein the device further comprises a status detecting module, a power extracting module and a switch module, the power extracting module being connected to the USB interface module, the switch module being connected to the USB interface module, and the status detecting module being connected to the switch module and the USB interface module, wherein
the status detecting module is adapted to detect voltages on USB interface signal lines to determine whether the signal voltage sequence of the USB interface signal lines is a USB protocol sequence;
the power extracting module is adapted to convert the voltages of input signals in any sequence to voltages in the USB protocol sequence; and
the switch module is adapted to switch a D+ signal line and/or a D− signal line arranged in the USB protocol sequence to an I/O interface, via which the device can exchange data, if the status detecting module determines that the signal voltage sequence accords with the USB protocol; otherwise, the device can exchange data with an upstream interface via D+ and D− interfaces on the basis of the USB protocol.

2. The device of claim 1, wherein the switch module is a switch chip, a controllable switch or a relay.

3. The device of claim 1, wherein the switch chip is a CD4052 chip.

4. The device of claim 2, wherein the switch chip is a CD4052 chip.

5. The device of claim 1, wherein the status detecting module is an interface detecting circuit.

6. The device of claim 2, wherein the status detecting module is an interface detecting circuit.

7. The device of claim 1, wherein the power extracting module is a silicon stack diode power converting circuit, a relay power converting circuit or a controllable switch power converting circuit.

8. The device of claim 7, wherein the relay power converting circuit comprises two relays which are reverse-connected with each other, each relay having two contacts which form two series loops which are reverse-connected, and a power output interface being connected between the two contacts of the series loops.

9. The device of claim 7, wherein the silicon stack diode power converting circuit comprises four bridge-connected diodes, wherein among the four output points, two output points each connecting a positive terminal of a diode and a negative terminal of another diode are connected to the USB interface module.

10. A method for a USB interface which can be used as a time-sharing standard I/O interface comprises the following steps:
connecting the device to an upstream interface; and
extracting power and detecting status for the upstream interface by the device, so that when the detected sequence of voltages on signal lines accords with the USB protocol, data can be exchanged according to the USB protocol by the device; otherwise, switching a D+ signal line and a D− signal line to a standard I/O interface via which data can be exchanged.

11. The method of claim 10, wherein the upstream interface is an upstream interface with which data is exchanged via a USB interface or an I/O interface.

12. The method of claim 10, wherein the voltage status on signal lines of the upstream interface with which data is exchanged via the I/O interface is arranged in any sequence.

13. The method of claim 10, wherein the step of extracting power for the upstream interface by the device comprises: adjusting the sequence of voltages on Vbus and Gnd signal lines to accord with the USB protocol to provide a normal voltage to the device.

14. The method of claim 10, wherein when data is exchanged by the device according to the USB protocol, if the sequence of the voltages on the signal lines is normal, the D+ and D− signal lines are connected to D+ and D− interfaces after passing through a switch, and the data is exchanged with the upstream interface according to the USB protocol.
